(19) United States
(12) Patent Application Publication
(10) Pub. No.: US 2004/0205592 A1
(43) Pub. Date: Oct. 14, 2004

(54) Method and apparatus for extensible stylesheet designs

(75) Inventor: Evan S. Huang, Cupertino, CA (US)

Correspondence Address: SILICON VALLEY PATENT AGENCY, INC., 7394 WILDFLOWER WAY, CUPERTINO, CA, 95014, US

(73) Assignee: XMLCITIES, INC., Milpitas, CA

(21) Appl. No.: 10/224,105

(22) Filed: Aug. 20, 2002

Related U.S. Application Data
(60) Provisional application No. 60/314,608, filed on Aug. 23, 2001.

(51) Int. Cl. G06F 17/24

(52) U.S. Cl. 715/513; 715/500

(57) ABSTRACT

Techniques for extensible stylesheet (XSL) design using composite definition association are disclosed. The designed stylesheets are for transferring content-oriented markup language files into a target file so as to support various presentations and information exchange. In the XSL design case, at least document definition files, such as document type definitions (DTD) or schema, for the source XML, the target makeup language file, and XSL are provided. An element can be selected in the XSL file or its corresponding document definition files. Subsequently, a composite child list is generated or obtained from the definition files. The composite child element list is used to restrict or suggest the possible child element for the selected element for the XSL design.

### CROSS-REFERENCE TO RELATED APPLICATION

This application claims the benefits of the U.S. provisional application No. 60/314,608, filed Aug. 23, 2001 and entitled “Method and Apparatus for Extensible Stylesheet Design Using Composite Definition Association”, which is hereby incorporated by reference for all purposes.

### BACKGROUND OF THE INVENTION

1. Field of the Invention

The present invention generally relates to the area of document processing and electronic publishing system and more particularly relates to a method and apparatus for designing or editing extensible stylesheets using composite definition association, where the designed extensible stylesheets are for various presentations and information exchange.

2. Description of the Related Art

The Internet is a rapidly growing communication network of interconnected computers around the world. Together, these millions of connected computers form a vast repository of hyperlinked information that is readily accessible by any of the connected computers from anywhere and anytime. With millions of web pages being created and added to this vast repository each year, there is a tremendous need to quickly and easily convert documents, such as presentations, data sheets or brochures, into a format presentable to and accessible by other applications or computers on the Internet.

It is well known that a preferable format that is presentable to a web browsing application (e.g. a browser) is in a markup language, such as Hypertext Markup Language (HTML), Extensible Markup Language (XML), Standard Generalized Markup Language (SGML) or Wireless Markup Language (WML). Files or documents that are so composed, edited or managed for web browsing applications are commonly referred to as structured files or documents. Among the structured documents, a content-oriented structured document like XML or SGML is capable of supporting any markup tags from document type definitions (DTD) or schema. And a presentation structured document like HTML and WML can only support a fixed set of markup tags, which can be interpreted by the browsing applications.

The ability to dynamically convert the content-oriented structured documents with proper style transformation for a particularly requested medium opens a new paradigm for information exchange and storage. To be more specific, For example, contents at website are stored in XML formats. If a web browser (e.g., Netscape or Internet Explorer) executing at a desktop computer requests certain information form the website, the website will convert corresponding content in XML into HTML and send the converted HTML files back to the browser. If a WAP device (e.g., a PDA or a data-capable cellular phone) requests information from the website, the website will convert the content in XML into WML and send the converted WML files back to the browser. Furthermore, the website can also convert the internal XML into another type of XML so as to exchange information among websites.

One critical technology in the aforementioned system for various publications and information exchange is the transformation from XML into various formats. There is therefore a need for approaches of extensible stylesheet designs to perform such transformation efficiently.

### SUMMARY OF THE INVENTION

This section is for the purpose of summarizing some aspects of the present invention and to briefly introduce some preferred embodiments. Simplifications or omissions may be made to avoid obscuring the purpose of the section. Such simplifications or omissions are not intended to limit the scope of the present invention. The present invention pertains to a process, an apparatus, a system and a software product for editing a stylesheet, wherein “editing” may mean designing, revising, creating or managing of a stylesheet that is typically used in conjunction with file transformation. For example, a stylesheet is used to facilitate the transformation of files in XML (eXtensible Markup Language) to HTML (HyperText Markup Language). According to one aspect of the present invention, techniques are developed to allow users to edit a stylesheet using composite definition association among elements in applicable document type definitions DTD so that all revisions can be effectuated in a target presentation.

According to one embodiment, the present invention is a method for designing a stylesheet. The method comprises importing a first type of document type definitions (DTD) pertaining to a target presentation, an extensible stylesheet file for the extensible stylesheet and a second type of second type definitions (DTD) pertaining to the extensible stylesheet; obtaining a child element list for a selected element when the element is selected in either one of the extensible stylesheet and the second type of DTD; obtaining an associate child element list for an associate element if the associate child element exists; and creating a composite child element list by combining the child element list for the selected element and the associate child element list for the associate element if there is one.

There are numerous advantages and features in the present invention. One of them is the mechanism that provides an environment in which a composite element list is created by combining a child element list for a selected element and an associate child element list for an associate element of the selected element. As a result, a new element pertaining to new information to be added to a corresponding stylesheet can be inserted in the composite list and the new information can be effectuated in a target presentation.

Other objects, advantages and benefits together with the foregoing are attained in the exercise of the invention in the following description and resulting in the embodiments illustrated in the accompanying drawings.

### BRIEF DESCRIPTION OF THE DRAWINGS

These and other features, aspects, and advantages of the present invention will become better understood with regard to the following description, appended claims, and accompanying drawings where:

FIG. 1 shows a basic system configuration in which the present invention may be implemented in accordance with a preferred embodiment;

FIG. 2A is an example of document type definitions (DTD) for recipe-type documents;

FIG. 2B shows an extensible markup language (XML) file based on the document type definitions (DTD) in FIG. 2A;

FIG. 3A shows an extensible stylesheet language (XSL) file, which transfers the XML file in FIG. 2B into an HTML file for a target presentation;

FIG. 3B shows a screenshot of the target presentation from the transferred HTML file of FIG. 3A;

FIG. 3C shows an XSL file, which transfers the XML file in FIG. 2B into a WML file;

FIG. 3D shows an XSL file, which transfers the XML file in FIG. 2B into another XML file;

FIG. 4A shows a fragment of HTML DTD;

FIG. 4B shows a fragment of XSL DTD;

FIG. 5A shows a screenshot of an XSL file, where a child element list of a selected HTML element is displayed with a drop down menu;

FIG. 5B shows a screenshot of an XSL file, where a child element list of a selected XSL element is displayed with a drop down menu;

FIG. 6A shows a screenshot of an XSL file, where a child element list of a selected HTML element with an unknown XSL element is displayed with a drop down menu;

FIG. 6B shows a screenshot of an XSL file, where the HTML portion of the composite child element list for a selected HTML element is displayed with a drop down menu;

FIG. 6C shows a screenshot of an XSL file, where the XSL portion of the composite child element list for a selected HTML element is displayed with a drop down menu;

FIG. 6D shows a screenshot of an XSL file, where the XSL portion of the composite child list for a selected XSL element is displayed with a drop down menu;

FIG. 6E shows a screenshot of an XSL file, where the HTML portion of the composite child list for a selected XSL element is displayed with a drop down menu;

FIG. 7 illustrates a process flowchart of creating a composite (child) element list for a selected element; and

FIG. 8 shows a process flowchart of creating a composite (child) element list for hybrid markup language files.

### DETAILED DESCRIPTION OF THE PREFERRED EMBODIMENTS

Broadly speaking, the present invention provides solutions for file transformation. More specifically, the present invention provides a method, an apparatus, a system and a software product for editing a stylesheet, wherein “editing” may mean designing, revising, creating or managing of a stylesheet that is typically used in conjunction with file transformation. For example, a stylesheet is used to facilitate the transformation of files in XML (extensible Markup Language) to HTML (HyperText Markup Language). According to one aspect of the present invention, techniques are developed to allow users to edit a stylesheet using composite definition association among elements in applicable document type definitions DTD so that all revisions can be effectuated in a target presentation

In the following description, numerous specific details are set forth in order to provide a thorough understanding of the present invention. However, it will become obvious to those skilled in the art that the present invention may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams representing one or more embodiments of the invention do not inherently indicate any particular order nor imply any limitations in the invention.

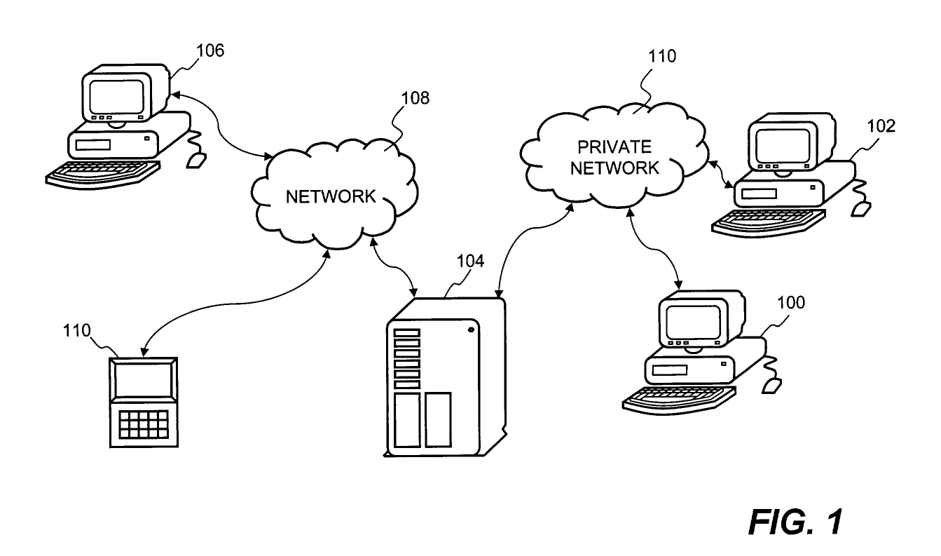

Referring now to the drawings, in which like numerals refer to like parts throughout the several views. FIG. 1 shows a basic system configuration in which the present invention may be implemented in accordance with a preferred embodiment. Content-oriented documents like XML files containing information, such as product descriptions, functions lists and price schedules, may be created using an authoring tool executed on a computer 100. The extensible stylesheets (XSL) to transfer the content-oriented documents into various presentations may be created in a computing device 102, which may be a server station or a desktop computer loaded with an executable version of one embodiment implementing the present invention.

In one setting, computer 100 and computing device 102 are inseparable and perform document conversion process for files that may be ultimately represented in a format of markup language such as WML or HTML. In one application, the content-oriented documents represented in XML and transformations in XSL become available through a private network 110 to a service server 104 that hosts what is generally referred to as a www (world wide web) site.

In one situation, a user uses a desk computer 106 that operates a browsing application and is coupled to data network 108 to access files on service server 104. These requested XML files will be converted into HTML files by proper XSL files and sent back to the desktop computer. In another situation, a user uses a PDA 110 that operates a WAP browsing application and is coupled to data network 108 to access files on service server 104. These requested XML files will be converted into WML files by corresponding XSL files and sent back to the PDA.

As will be explained below, the present invention is not limited to the Internet applications. It may be practiced in individual computers in which users often create the XSL files to convert the XML files into the HTML or WML files off-line. Since the content and presentation are separated, users can easily create another set of XSL files for different look-and-feel. Also it will be appreciated herein that the present invention can be equally applied to other markup languages that are used to express contents in a way that can be conveniently transformed for a target present presentation. Without obscuring aspects of the present invention, the description herein is based on XML (Extensible Markup Language).

XML provides a flexible way to create common information formats and share both the format and the data on the World Wide Web, intranets, and elsewhere. For example, computer makers may agree on a standard or common way to describe the information about a computer product (processor speed, memory size, and so forth) and then describe the product information format with XML. Such a standard way of describing data would enable a user to send an intelligent agent (a program) to each computer maker's Web site, gather data, and then make a valid comparison. XML can be used by any individual or group of individuals or companies that wants to share information in a consistent way.

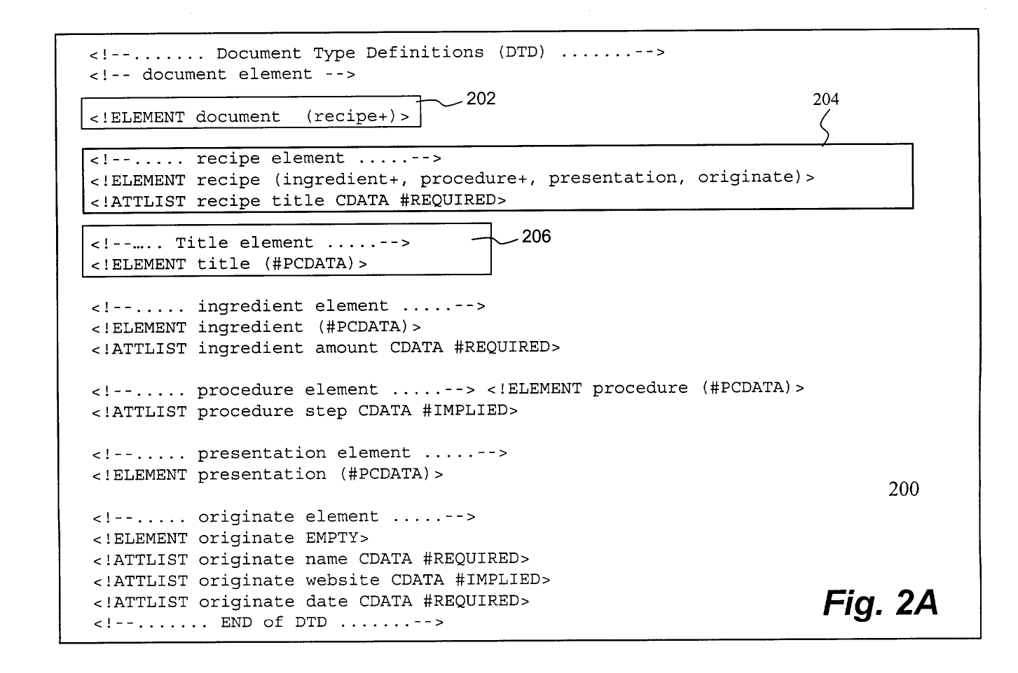

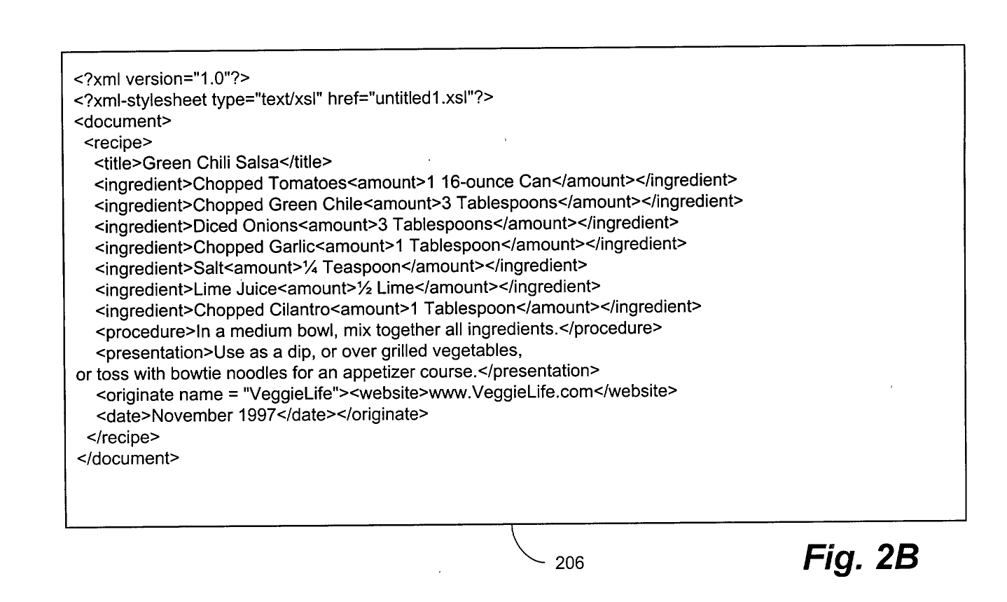

A content-oriented document in XML is associated with a document definition file such as document type definitions (DTD) or schema to define document elements in the XML file. FIG. 2A illustrates an example of DTD 200 pertaining to an XML file for “recipe-type” documents. In accordance with the DTD 200, a document is to be broken down into structures of elements. A particular element, “document” 202 indicated by a “+” sign may contain multiple instances of the same child element. An element 204 may contain several other elements and attributes while element 206 contains only the parsed character data. FIG. 2B shows an example of the correspond XML file, where information are represented in parsed data elements defined in accordance with document type definitions (DTD) in FIG. 2A.

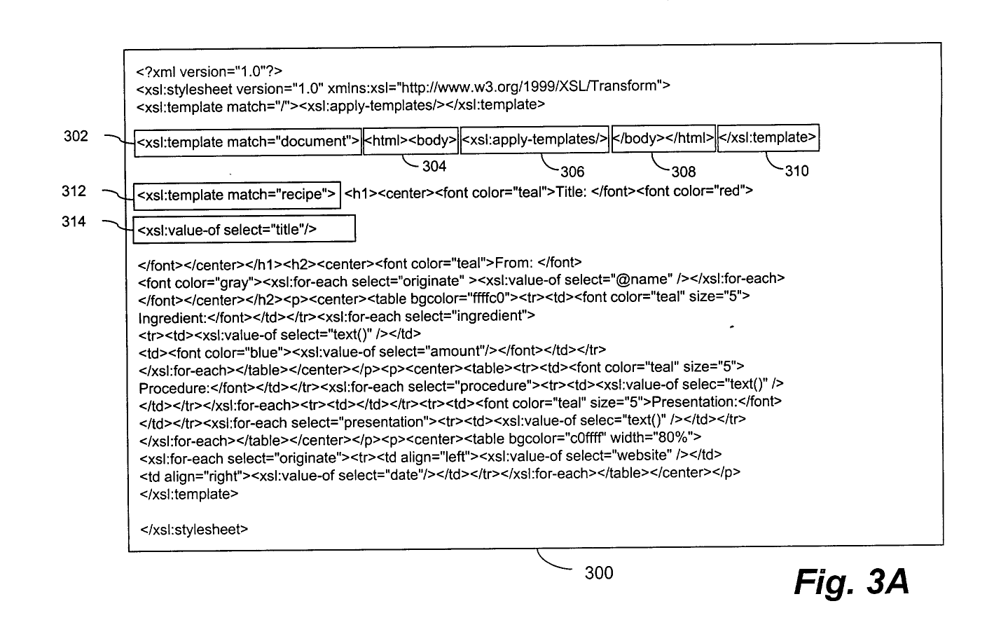

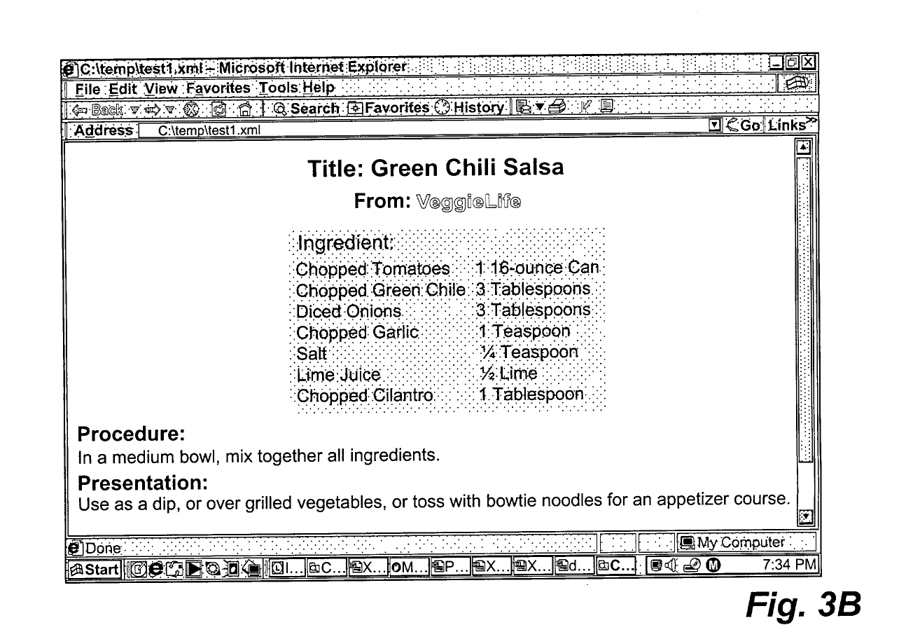

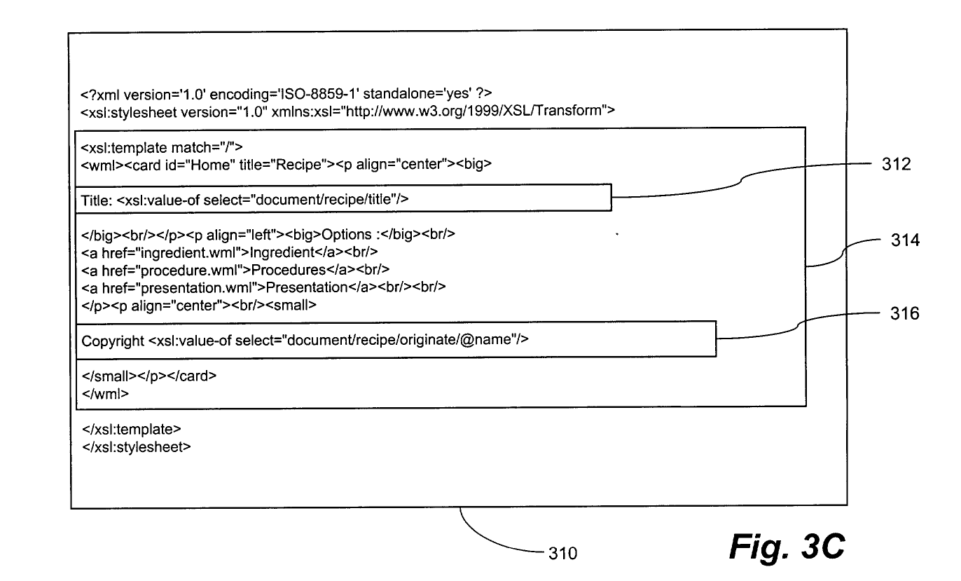

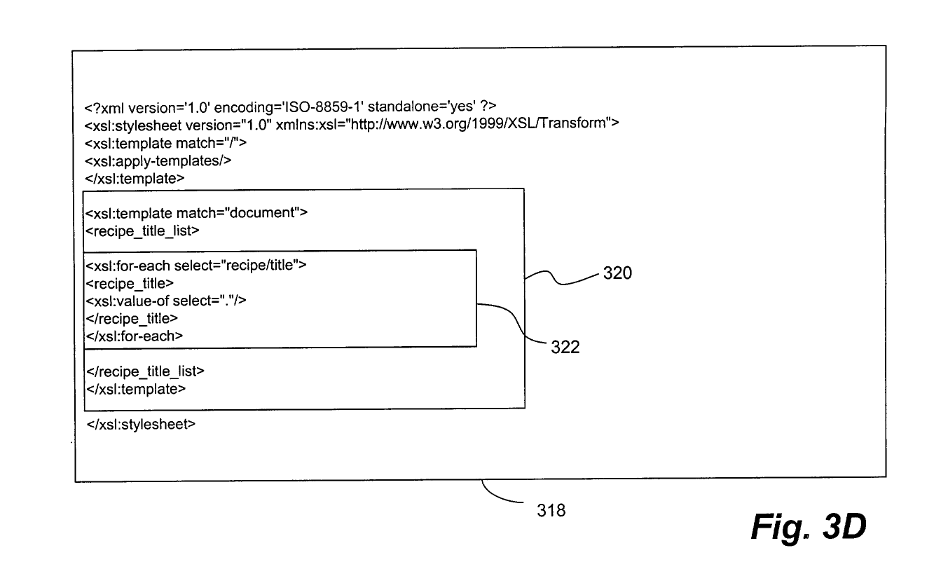

An XML file can be transferred into various presentations using extensible stylesheets expressed in XSL. An example of an XSL file, which converts the XML file 208 of FIG. 2B into an HTML file, is given in FIG. 3A. In particular, blocks, 304 and 308, show that the top level <html> and <body> tags are created when the XSL file matches a particular tag, “document”, in 302. Block 306 illustrates how to apply a template to the child element of “document”. In this example, the applied template is matched by block 312 because “recipe” is the only child element of “document” as shown in 202. And block 314 shows how to assign the value associated with “title” in the source XML file to the target HTML file. The screenshot of the resulted HTML is given in FIG. 3B.

Another example of an XSL file, which converts the XML file 208 into a WML file, is given in FIG. 3C. In particular, block 324 shows that the top level <wml> tag is created when the XSL file matches the root element, block 322 shows how to assign the “title” value in the source XML file to the target WML file, and block 326 shows how to assign the “name” attribute of the “originate” element in the source XML file to the target WML file.

Other than transferring an XML file into various presentations, an XSL file can also transfer an XML file into another XML file with a different DTD or schema. The primary reason for this type of transformation is for information exchange between different systems.

FIG. 3D shows an example of an XSL file, which converts the XML file 208 into another XML file of a list of the recipe titles. In particular, block 332 shows that the top level <recipe_title_list> tag is created when the XSL file matches the “document” element and block 334 shows how to assign each of the “title” values in the source XML file to the <recipe_title> tag in the target XML file.

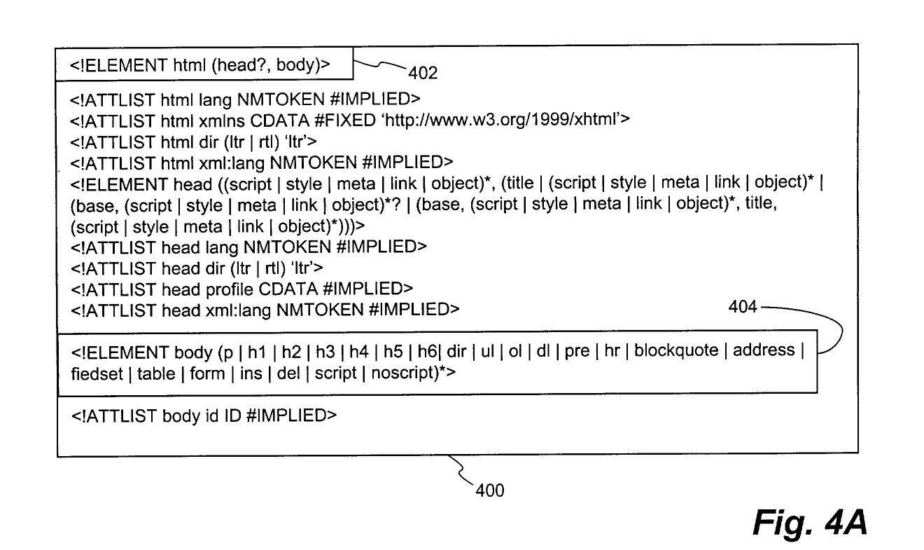

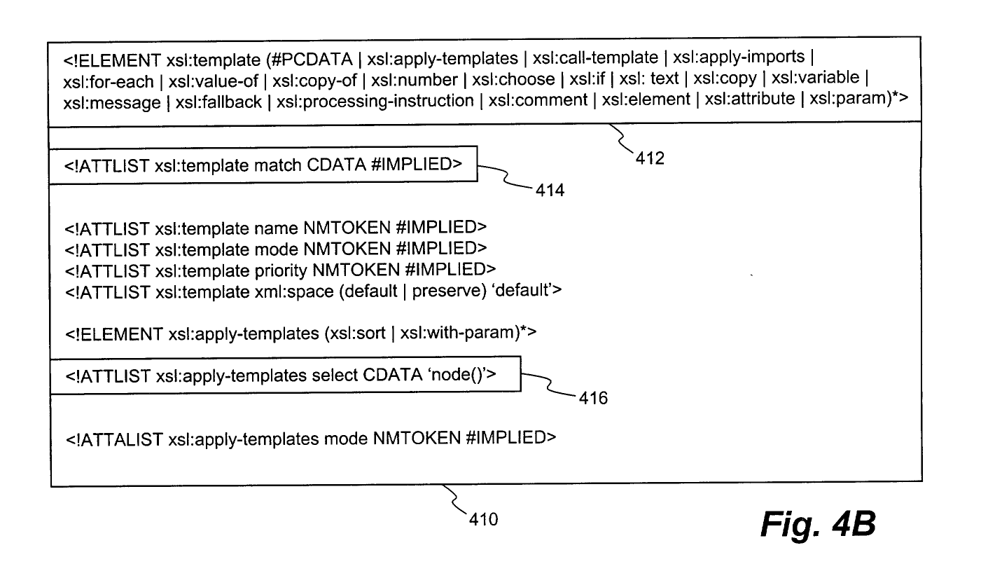

From the above XSL examples, one can see that an XSL file is a combination of the target file, such as HTML, WML, or XML, and <xsl:> tags from the XSL definitions through the information from the source XML file and/or the source XML's DTD or schema file. FIG. 4A shows a fragment of HTML's DTD. In particular, the “html” element 402 has two child elements, “head” and “body”, and the “body” element 404 contains a list of child elements 404.

FIG. 4B shows a fragment of XSL's DTD. In particular, the child elements of the “xsl:template” element in an XSL file are from choices of a list of child element 412. And the “match” attribute of the “xsl:template” element 414 will identify the associated element in the source XML tree. Furthermore, the “xsl:apply-template” will apply matched template to the selected element in the source XML tree through the “select” attribute 416.

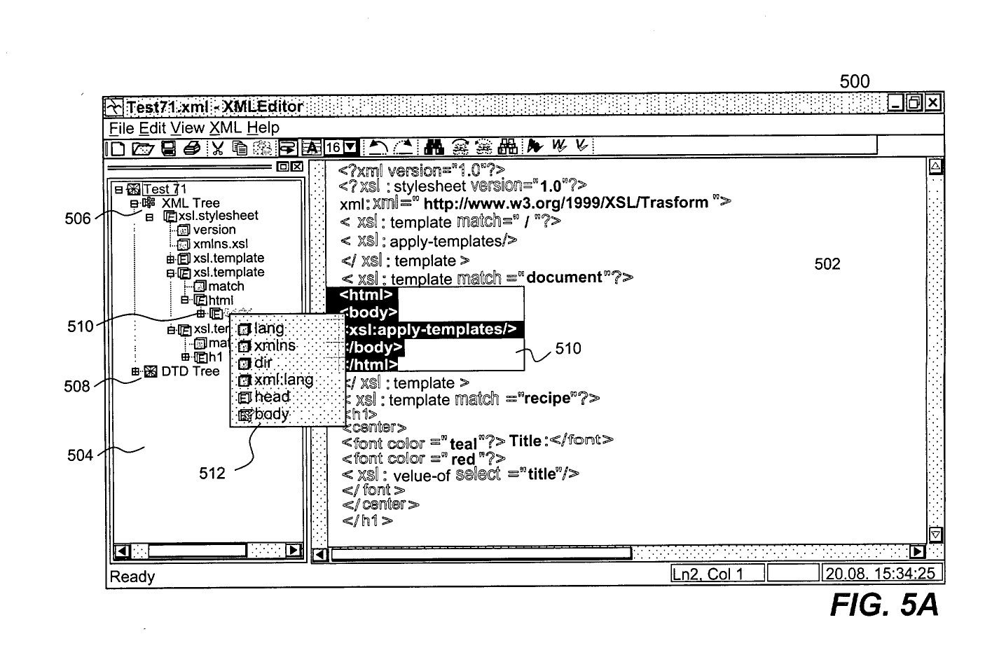

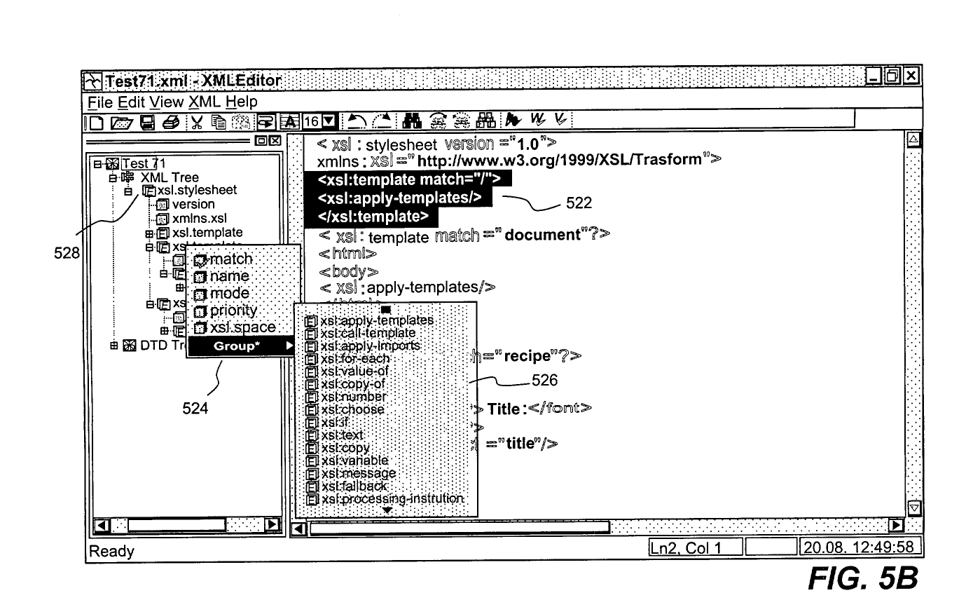

Based on the information of document definition files such as DTD or Schema, a child element list can be generated or obtained for a selected element. According to one embodiment, FIG. 5A shows an editing environment 500 in which a stylesheet 502 is displayed and to be edited or designed. FIG. 5A as well as 5B may be better understood in conjunction with FIGS. 4A and 4B. To facilitate the editing of the stylesheet 502, the environment 500 also provides a second view 504 to illustrate an XML tree 506 and a DTD 508 for a target representation (e.g., HTML). As described above and also illustrated in FIG. 5A, the XML tree 506, directly or generated from a DTD for the stylesheet 502, includes a number of attributes and elements. An element may be selected in the XML tree 506 or directly in stylesheet 502. The DTD 508 pertains to the target representation (e.g., for HTML files).

As shown in FIG. 5A, an element “html” 510 is selected and is shown that the element 510 has a child element list 512 that is created or obtained in accordance with the HTML's DTD fragment given in FIG. 4A. In the child element list 512, the “body” element has been crossed out since it already exists as the child element for the selected “html” element 510. Likewise, a similar example is given in FIG. 5B, where a selected element, “xsl:template”, 522 has a child element list 526 and an attribute list 524, in which the existing “match” attribute is checked. And the child element list and the attribute list are created in accordance with the XSL's DTD fragment given in FIG. 4B.

The child element lists 512 and 524 as shown in FIG. 5A and FIG. 5B are respectively restricted to their associated DTDs. Namely, the child element lists 512 is from the DTD 508 and the child element 524 is from the XML tree (or DTD) 528. To create a similar child element list for designing an XSL file is usually a challenge because an XSL file, as mentioned previously, is a combination of the target file, such as HTML, WML, or XML, and <xsl:> tags from the XSL definitions through the information from the source XML file and/or the source XML's DTD or schema file. Therefore, the child element list is usually composed of elements from two separate DTDs for the target file and for the XSL, respectively.

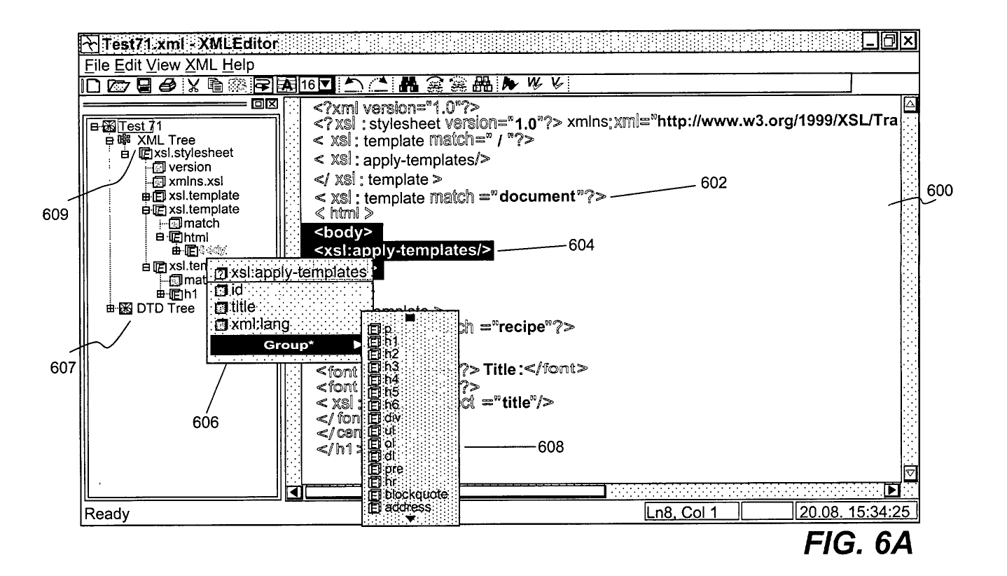

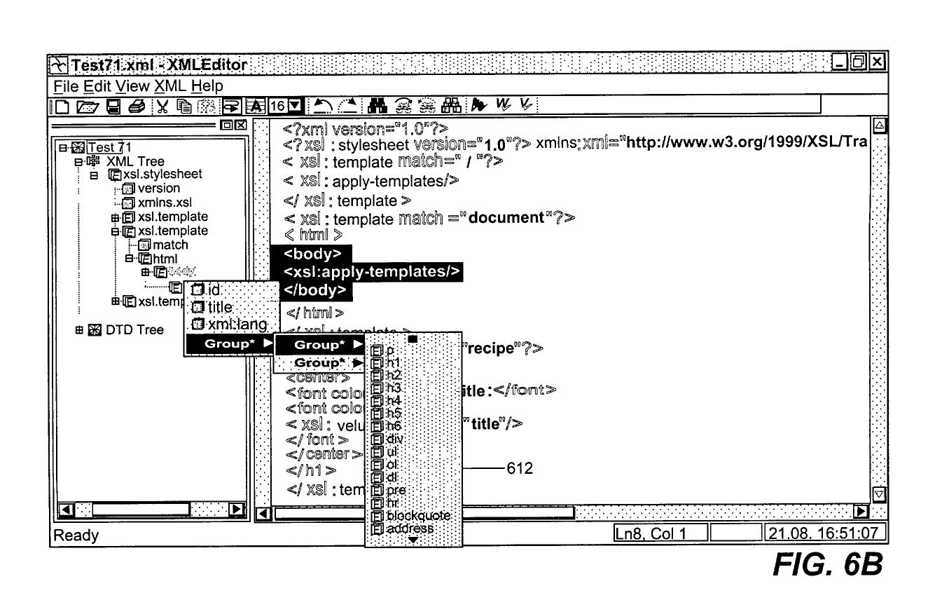

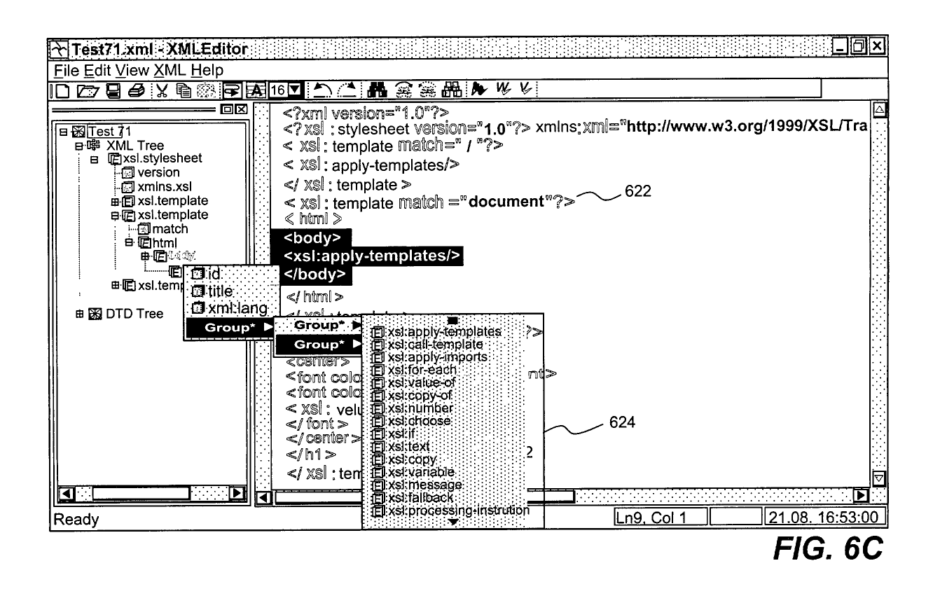

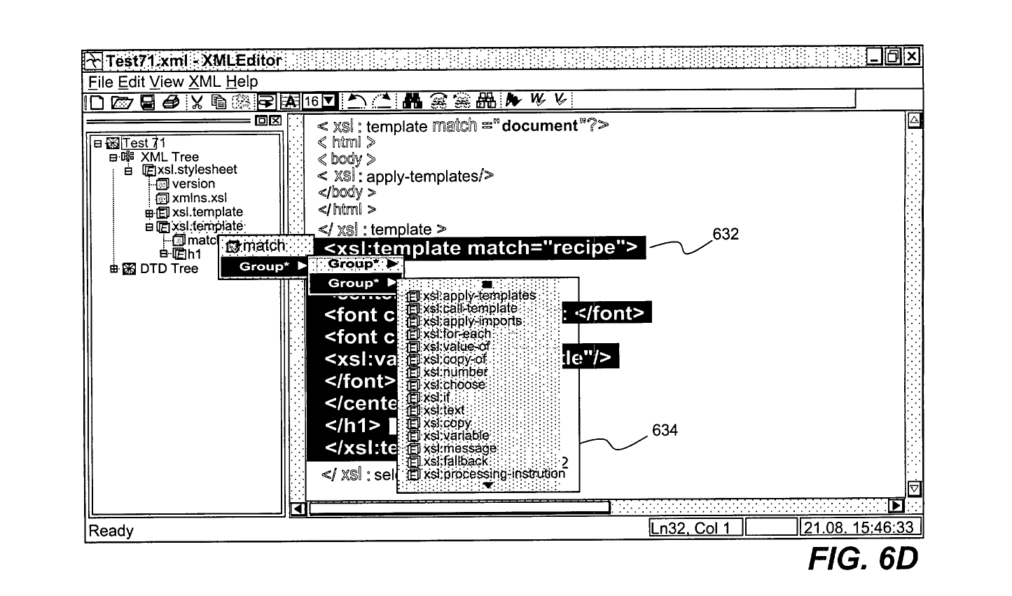

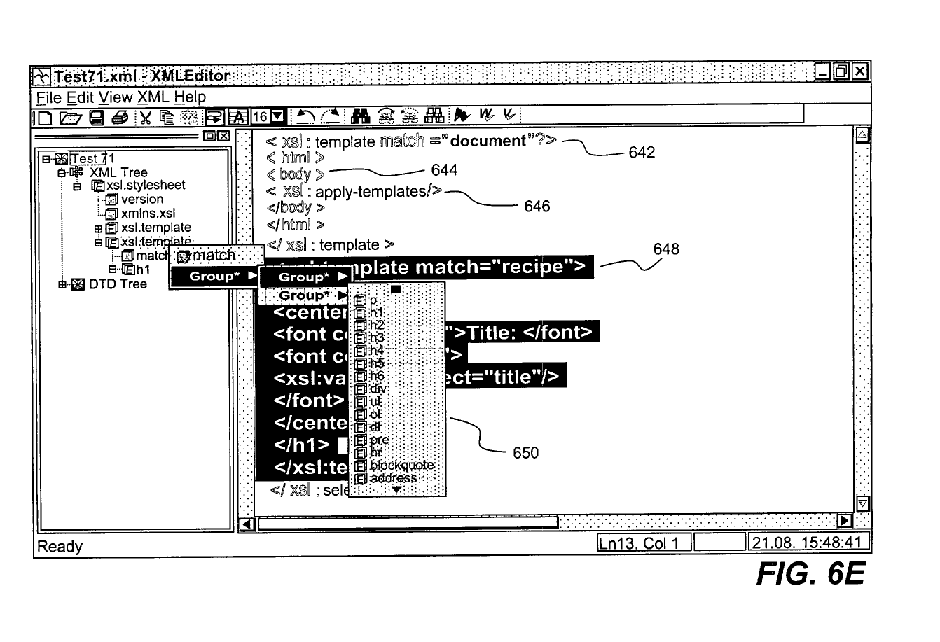

FIG. 6A shows an example of an XSL file 600, where the child element list 606 is built only based on the HTML DTD 607. In particular, the selected “body” element 604 is a child element of “html” and both elements are from the HTML DTD 607. The child “xsl:apply-template” element of the selected “body” element is from the XSL DTD 609 and applies a template to the child elements of “document” in the source XML file. This association is through the “match” attribute of the “xsl:template” element 602, which is a parent element of “html”. Since the child element list, 606 and 608, for the selected “body” element is built only based on the HTML DTD 607, the “xsl:apply-template” element 604 will be treated as an inserted element, which is shown in 606 with a question mark in front as an indication.

FIGS. 6B and 6C show a composite child element list of the selected “body” element 604. In particular, the HTML portion of the composite child element list is shown in 612, which is identical to the child element list given in 608. And the XSL portion of the composite child element list 624 is created by the child elements of an associate element in the XSL's document definition file, where the associate element is found by propagating back the parent elements of the selected element to reach the first element in the XSL. In this case, the associate element is “xsl:template” and its child elements are given in 412 of FIG. 4B.

FIGS. 6D and 6E show another example of a composite child element list of a selected “xsl:template” element 632. Since the “xsl:template” belongs to the XSL, the XSL portion of the composite child element list 634 can be directly created from the XSL's document definition file 412. And the HTML portion of the composite child element list 650 is created by the child elements of an associate element in the HTML. In this example, the associate element is found by an indirect linking through the source XML elements. In particular, the “match” attribute of the selected “xsl:template” element specifies that the “recipe” element in the source XML element is matched by this template 648. In the source XML's DTD 200 of FIG. 2A, the “recipe” is a child element of “document” 202, that links to the “xsl:template” with a matched “document” element 642. And the “xsl:apply-template” 646 applies templates to the child elements of the “document” element in the XML file. Therefore, the associate element in the HTML is the parent element of the “xsl:apply-template” element 646, which is the “body” element 644. And the HTML portion of the composite child element list 650 is from the child elements given in 404 of FIG. 4A.

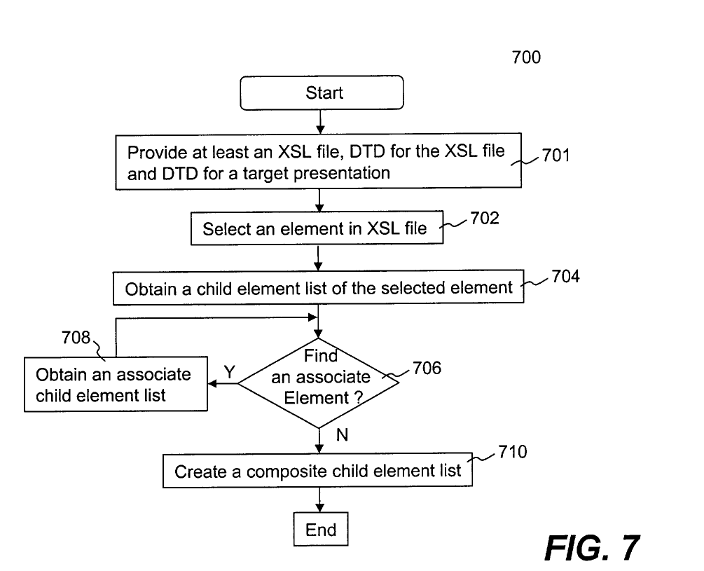

FIG. 7 shows a process flowchart 700 for creating a composite child element list for a selected element as such a new child element can be inserted to edit an XSL file. The process 700 may be implemented as a method, apparatus and a software product. In general, a graphic environment, although not necessary, is desirable for users to work on editing a stylesheet. The graphical environment may correspond to the environment 500 of FIG. 5A and is typically provided or loaded with an XSL file, a corresponding DTD of the XSL file and a DTD of an output presentation (e.g., HTML or WML).

Accordingly at 701, an XSL file to be edited as well as its corresponding DTD, and the DTD of the target presentation are provided. According to one embodiment, a graphical environment is configured to have at least two views or windows. One of the windows is to display the XSL file as the stylesheet to be edited and the other window is to display an XML tree and the DTD for the target presentation. The XML tree is generated from the DTD for the stylesheet being displayed. In a case that there are multiple XSL-templates in the XSL file, the original XML file or files shall be loaded to facilitate the distinction of the respective XSL-templates.

At 702, a desired element is selected from the XSL file. Given a graphical environment, the desired element can be selected graphically from the displayed stylesheet (e.g., 502 of FIG. 5). Depending on the nature of the selected element, the element may belong to the corresponding DTD of the XSL file or the DTD of the target presentation. In any case, a child element list for the selected element is obtained at 704. Depending on the selected element, the child element list may be obtained from the XSL's DTD, or the DTD for the output presentation or both of the XSL's DTD and output's DTD.

At 706, one or more associate elements are searched. If one associate element is found, the process 700 goes to 708 where a child element list for the associate element is created or obtained. The child element list 412 of FIG. 4B is one exemplary list for an associate element. The process 700 goes back to 706 to look for a next associate element till all available associate elements are found and their corresponding child element lists are obtained. When there are no more associate elements, the process goes to 710 where the child element lists for the selected element as well as the associate element(s) are combined logically. The logically combined child element lists are referred to herein as a composite child element list.

In operation, with the composite child element list, a user can design or edit the stylesheet being available or displayed in accordance with the composite child element list. In particular, the user can insert a new element in the composite child element list, that new element defines logically where information (new or revised) can be entered in the stylesheet. As a result, the new information will be effectuated in the target presentation via the stylesheet.

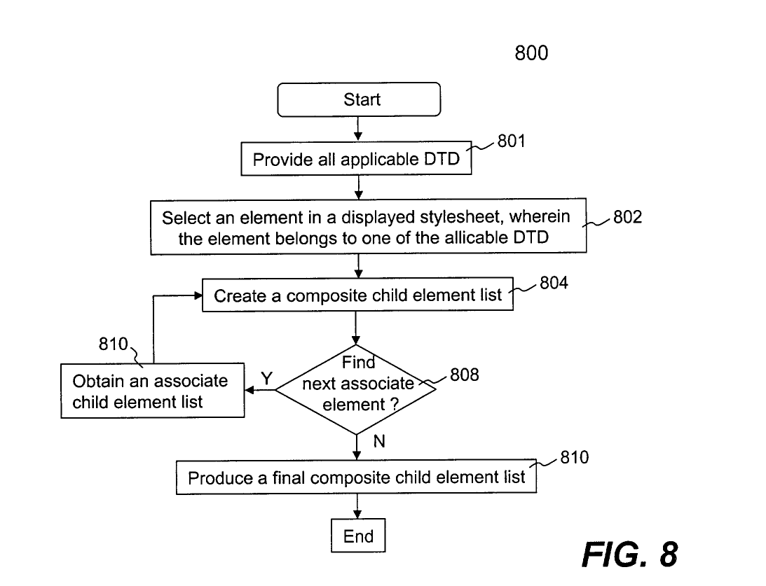

It should be noted that the composite child element list is built or created based upon two document definition files (DTD for the target presentation and DTD for the stylesheet), the same approach can be applied to create a child element list for any hybrid markup language files with multiple document definition files. FIG. 8 shows a process flowchart 800 to create a composite child element list for hybrid markup language files. At 801, applicable DTD are provided. For example, if there are N types of markup languages (not necessary that all are distinct), N DTD shall be provided. At 802, an element is selected in a stylesheet and the selected element may belong to any one of the applicable DTD. At 804, a child element list is obtained from its corresponding DTD of the selected element. Then, the process 800 is configured to find an associate element for each of the DTD at 806, 808 and 810 till all of the associate element is found. In other words, a temporary composite child element list is obtained at 806. The process 800 goes to find a next associate element in one of the other DTD. If there is one, the process goes to 810 to obtain an associate child element list that is to be used to update the temporary composite child element list originally obtained at 806. The process 800 keeps going on till that no more associate element can be found at 808. The process 800 then goes to 812 to produce a final composite child element list.

The foregoing description of embodiments is illustrative of various aspects/embodiments of the present invention. Various modifications to the present invention can be made to the preferred embodiments by those skilled in the art without departing from the true spirit and scope of the invention as defined by the appended claims. Accordingly, the scope of the present invention is defined by the appended claims rather than the foregoing description of embodiments.

I claim:

1. A method for designing an extensible stylesheet, the method comprising:
providing a first type of document definitions files pertaining to a target presentation, an extensible stylesheet file for the extensible stylesheet and a second type of document definitions files pertaining to the extensible stylesheet;
obtaining a child element list for a selected element in the extensible stylesheet file, wherein the selected element belongs to either the first type or the second type of document definitions files;
obtaining an associate child element list for an associate element if the associate child element exists; and
creating a composite child element list by combining the child element list for the selected element and the associate child element list for the associate element if there is one.

2. The method as recited in claim 1 further comprising allowing a new element to be inserted in the extensible styesheet file from the composite child element list.

3. The method as recited in claim 2, wherein the new element pertains to information to be entered in the extensible stylesheet.

4. The method as recited in claim 1, wherein the obtaining of the associate child element list for the associate element comprises finding the associate element for the selected element by propagating back parent elements of the selected element to reach a first element belonging to a different type of document definition file.

5. The method as cited in claim 1 further comprising importing one or more XML files that are intended to be converted to files for the target presentation via the stylesheet.

6. The method as cited in claim 5, wherein the files for the target presentation are in a markup language.

7. The method as cited in claim 6, wherein the markup language is one of XML, WML, and HTML.

8. The method as cited in claim 5, wherein the obtaining of the associate child element list for the associate element comprises finding the associate element for the selected element by an indirect linking through elements in the one or more XML files.

9. The method as cited in claim 1, wherein the extensible stylesheet is in a markup language and allows editing to be made therein.

10. The method as cited in claim 9, wherein the editing can only be made in accordance with a new element that can be inserted in the extensible stylesheet from the composite child element list such that the editing can be effectuated in the target presentation.

11. A method for designing an extensible stylesheet, the method comprising:
displaying a graphic environment with at least a first display window and a second display window, the first display window displaying the extensible stylesheet, and the second display window displaying a first type of document definitions files pertaining to a target presentation, and a second type of document definitions files pertaining to the extensible stylesheet;
selecting an element by highlighting an element in the first display window, wherein the highlighted element belongs to either the first type or the second type of document definitions files;
obtaining a child element list for the selected element;
obtaining an associate child element list for an associate element if the associate child element exists; and
creating a composite child element list by combining the child element for the selected element and the associate child element list for the associate element if there is one.

12. A software product to be executable in a computing device for designing an extensible stylesheet, the software product comprising:
program code for providing a first type of document definitions files pertaining to a target presentation, an extensible stylesheet file for the extensible stylesheet and a second type of document definitions files pertaining to the extensible stylesheet;
program code for obtaining a child element list for a selected element in the imported extensible stylesheet file, wherein the selected element belongs to either the first type or the second type of document definitions files;
program code for obtaining an associate child element list for an associate element if the associate child element exists; and
program code for creating a composite child element list by combining the child element list for the selected element and the associate child element list for the associate element if there is one.

13. The software product as recited in claim 12 further comprising program code for allowing a new element to be inserted in the extensible stylesheet from the composite child element list.

14. The software product as recited in claim 13, wherein the new element pertains to information to be entered in the extensible stylesheet.

15. The software product as recited in claim 12, wherein the program code for obtaining the associate child element list for the associate element comprises program code for finding the associate element for the selected element by propagating back parent elements of the selected element to reach a first element belonging to a different type of document definition file.

16. The software product as cited in claim 12 further comprising program code for importing one or more XML files that are intended to be converted to files for the target presentation via the stylesheet.

17. The software product as cited in claim 16, wherein the files for the target presentation are in a markup language.

18. The software product as cited in claim 12, wherein the program code for obtaining the associate child element list for the associate element comprises program code for finding the associate element for the selected element by an indirect linking through elements in the one or more XML files.

19. The software product as cited in claim 12, wherein the extensible stylesheet is in a markup language and allows editing to be made therein.

20. The software product as cited in claim 19, wherein the editing can only be made in accordance with a new element that can be inserted in the composite child element list such that the editing can be effectuated in the target presentation.
